(19) United States
(12) Patent Application Publication
(10) Pub. No.: US 2007/0150309 A1
(43) Pub. Date: Jun. 28, 2007

(54) Health and wellness guidance system

(76) Inventors: Michael Taylor, Morton, IL (US); Linda Lavaux, Washington, IL (US); Anita Winslow, Peoria, IL (US); Peggy Sprague, Eureka, IL (US); Jennifer Hartsock, Goodfield, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/315,288

(22) Filed: Dec. 23, 2005

(51) Int. Cl. G06Q 10/00; G09B 23/28

(52) U.S. Cl. 705/2; 434/262

(57) ABSTRACT

A health and wellness guidance system is provided. The system may include a memory configured to store health-related information about individual members of a population. The system may also include a processor operatively coupled to the memory and configured to assemble at least one tailored health risk assessment questionnaire package tailored for an individual member of the population. The assembly may be performed in response to at least one of the following: an update to the health-related information stored in the memory, and an addition of new health-related information to the memory.

### TECHNICAL FIELD

The present disclosure is directed to the field of healthcare, and more particularly, to a tailored questionnaire system.

### BACKGROUND

Healthcare costs have been rising at a staggering rate over the past two decades. In response, individuals, businesses, and insurance carriers have been seeking ways to lower healthcare costs. For instance, the rise in the use of health maintenance organizations (HMO's) is one attempt to gain control of the costs of healthcare.

While controlling costs is one way to reduce the costs of healthcare, one of the best ways to reduce the costs of healthcare is to reduce the demand for healthcare by maintaining and improving the health of members of a targeted population of people. Not only does this reduce the costs of healthcare for the insurer and those paying premiums, but it also increases the quality of life for those whose health is improved in the process. The life expectancy and quality of life of population members may be improved by helping individuals gain the knowledge, motivation, and opportunities they need to make informed decisions about their health, and/or by reinforcing healthy medical practices and lifestyles.

Thus, a comprehensive health promotion/disease prevention program can reduce demand-side costs. Such a comprehensive program may include the following components: customized self-care books and newsletters for the targeted population; tracking of health needs; segmentation of the population into risk cohorts; individualized interventions; incentives to maximize participation; integration with existing healthcare programs, such as employee assistance programs; and health exams. In addition, a comprehensive program may also include health risk assessment questionnaires to facilitate monitoring of important healthcare factors. Such questionnaires may administer targeted questions to individual members of the targeted population. A comprehensive program may further include dissemination of packages of health-related information. Such packages may include feedback regarding answers submitted in response to health risk assessment questionnaires.

Preventable illness makes up a large percentage of the burden of illness and its associated costs. Preventable causes of illness, led by cigarette smoking, lack of exercise, and poor diet, represent many of the leading causes of death in the U.S. Self-efficacy, the confidence gained by accepting accountability for one's lifestyle choices, can be an essential prerequisite for subsequent changes in health behaviors. Researchers and experts have shown that appropriate healthcare utilization is linked to the presence or absence of personal self-efficacy and to the availability of well-presented information. Dissemination of health risk assessment questionnaires and health-related information can be substantial factors in achieving self-efficacy.

Systems have been developed for monitoring and/or promoting health and wellness of a targeted population. For example, U.S. Patent Application Publication No. 2003/0004788, filed by Edmundson et al. and published on Jan. 2, 2003 (“the '788 publication”), discloses a targeted questionnaire system for healthcare. The '788 publication discloses generating a targeted questionnaire based on potential answers to a prior questionnaire.

While the '788 publication may be configured to establish a health risk assessment of a targeted population, one or more improvements could be made to the system of the '788 publication. For example, the '788 publication discloses generating a targeted questionnaire based on potential answers to a prior questionnaire. That is, the targeted questionnaire is pre-assembled (and therefore pre-established) and sent out to whoever answers the prior questionnaire in a particular, predicted manner. Therefore, the same questionnaire is administered to whomever it applies. The same process may occur for a number of different health risk assessment strategies (e.g., smoking cessation, diabetes screening, etc.). For each strategy, one or more questionnaires is pre-assembled (and therefore pre-established) based on possible answers to the questions in a prior questionnaire. Each questionnaire is administered to a targeted population of members to whom the questionnaire applies based on answers to the prior questionnaire. Therefore, members may be administered several questionnaires, one for each strategy that applies to them.

Improvements could be made to the system of the '788 publication, such that, instead of pre-establishing a targeted questionnaire before answers to prior questionnaires are even received, a tailored questionnaire may be assembled for an individual member in response to updates and/or additions to the individual member's health-related data (e.g., answers to a prior questionnaire).

The present disclosure is directed to improvements in existing health and wellness guidance systems.

### SUMMARY OR THE INVENTION

In one aspect, the present disclosure is directed to a health and wellness guidance system. The system may include a memory configured to store health-related information about individual members of a population. The system may also include a processor operatively coupled to the memory and configured to assemble at least one tailored health risk assessment questionnaire package tailored for an individual member of the population. The assembly may be performed in response to at least one of the following: an update to the health-related information stored in the memory, and an addition of new health-related information to the memory.

In another aspect, the present disclosure is directed to a method for guiding health and wellness behavior of members of a targeted population. The method may include assembling at least one tailored health risk assessment questionnaire package tailored for an individual member of the population. The assembly may be performed in response to at least one of the following: an update to health-related information stored in a memory, and an addition of new health-related information to the memory.

In another aspect, the present disclosure is directed to a computer-readable medium having stored thereon machine executable instructions for guiding health and wellness behavior of members of a population. The instructions may include the step of assembling at least one tailored health risk assessment questionnaire package tailored for an individual member of the population. The assembly may be performed in response to at least one of the following: an update to health-related information stored in a memory, and an addition of new health-related information to the memory.

### BRIEF DESCRIPTION OF THE DRAWINGS

FIG. 1 illustrates a health and wellness guidance system according to an exemplary disclosed embodiment.

FIG. 2 illustrates different types of health-related information stored in a database according to an exemplary disclosed embodiment.

FIG. 3 is a block diagram illustrating an exemplary database building and information disseminating functions of the health and wellness guidance system.

FIG. 4 is a flow chart illustrating an health risk assessment question approval process according to an exemplary disclosed embodiment.

FIG. 5 is a flow chart illustrating assembly of health risk assessment questionnaire packages according to an exemplary disclosed embodiment.

FIG. 6 is a flow chart illustrating a health-related information approval process according to an exemplary disclosed embodiment.

FIG. 7 is a flow chart illustrating assembly of health-related information packages according to an exemplary disclosed embodiment.

### DETAILED DESCRIPTION

Reference will now be made in detail to the drawings. Wherever possible, the same reference numbers will be used throughout the drawings to refer to the same or like parts.

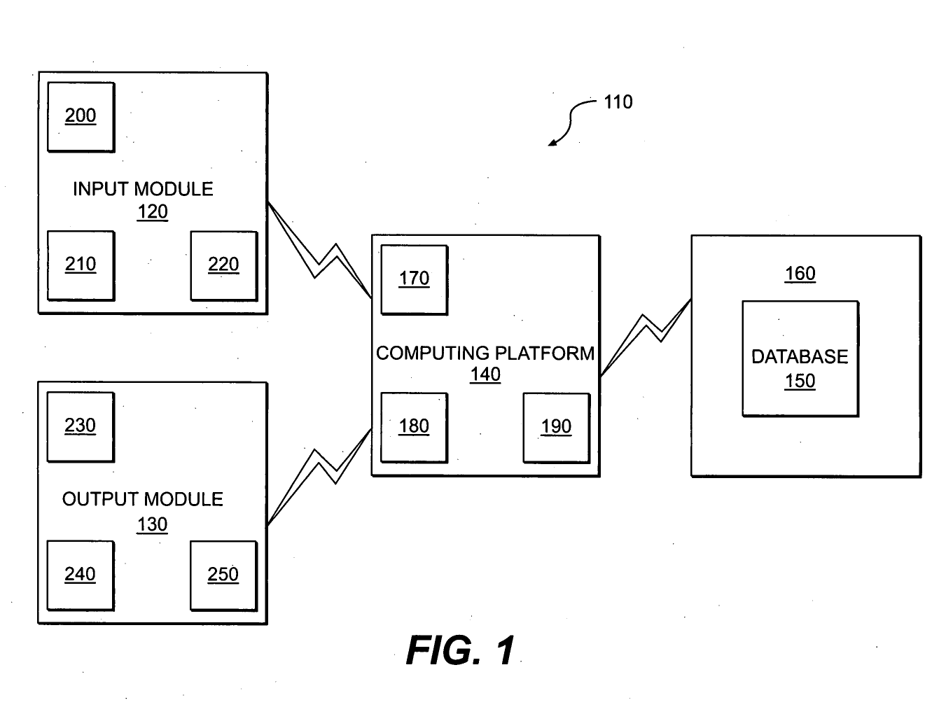

FIG. 1 illustrates a health and wellness guidance system 110. System 110 may include an input module 120, an output module 130, and a computing platform 140. Computing platform 140 may include or may be otherwise operatively coupled to a database 150, which may be stored in a memory 160. Database 150 may include more than one database or other type of electronic repository. Computing platform 140 may be adapted to include the necessary functionality and computing capabilities to implement health risk assessment (HRA) strategies input through input module 120 and access, read, and write to database 150. The results of analyzing data may be provided as output from computing platform 140 to output module 130 for printed display, viewing, and/or further communication to other system devices. Such output may include, for example, one or more questionnaires or information packages. Output from computing platform 140 can also be provided to database 150, which may be utilized as a storage device for health-related information about individual members of a population.

In the embodiment of FIG. 1, computing platform 140 may include a PC or mainframe computer configured to perform various functions and operations. Computing platform 140 may be implemented, for example, by a general purpose computer selectively activated or reconfigured by a computer program stored in the computer, or may be a specially constructed computing platform for carrying out the features and operations of system 110. Computing platform 140 may also be implemented or provided with a wide variety of components or subsystems including, for example, one or more of the following: a processor 170, a co-processor 180, a register 190, and/or other data processing devices and subsystems. Computing platform 140 may also communicate or transfer HRA strategies, questionnaires, and feedback to and/or from input module 120 and output module 130 through the use of direct connections or communication links, as illustrated in FIG. 1. In an exemplary embodiment, a firewall may prevent access to the platform by unauthorized outside entities.

Alternatively, communication between computing platform 140 and module 120 and module 130 can be achieved through the use of a network architecture (not shown). In such an embodiment, the network architecture may comprise, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, computing platform 140 may be located in the same location or at a geographically distant location from input module 120 and/or output module 130.

Input module 120 may include a wide variety of devices to receive and/or provide the data as input to computing platform 140. As illustrated in FIG. 1, input module 120 may include an input device 200, a storage device 210, and/or a network interface 220. Input device 200 may include a keyboard, mouse, touchscreen, disk drive, video camera, magnetic card reader, or any other suitable input device for providing data to computing platform 140. Memory 160 may be implemented with various forms of memory or storage devices, such as read-only memory (ROM) devices and random access memory (RAM) devices. Storage device 210 may include a memory tape or disk drive for reading and providing data on a storage tape or disk as input to computing platform 140. Network interface 220 may be configured to receive data over a network (such as a LAN, WAN, intranet or the Internet) and to provide the same as input to computing platform 140. For example, network interface 220 may be connected to a public or private database over a network for the purpose of receiving information about the covered population from computing platform 140.

Output module 130 may include a display 230, a printer device 240, and/or a network interface 250 for receiving the results provided as output from computing platform 140. As indicated above, the output from computing platform 140 may include one or more questionnaires or information packages. The output from computing platform 140 may be displayed or viewed through display 230 (such as a CRT or LCD) and printer device 240. If needed, network interface 250 may also be configured to facilitate the communication of the results from computing platform 140 over a network (such as a LAN, WAN, intranet or the Internet) to remote or distant locations for further analysis or viewing.

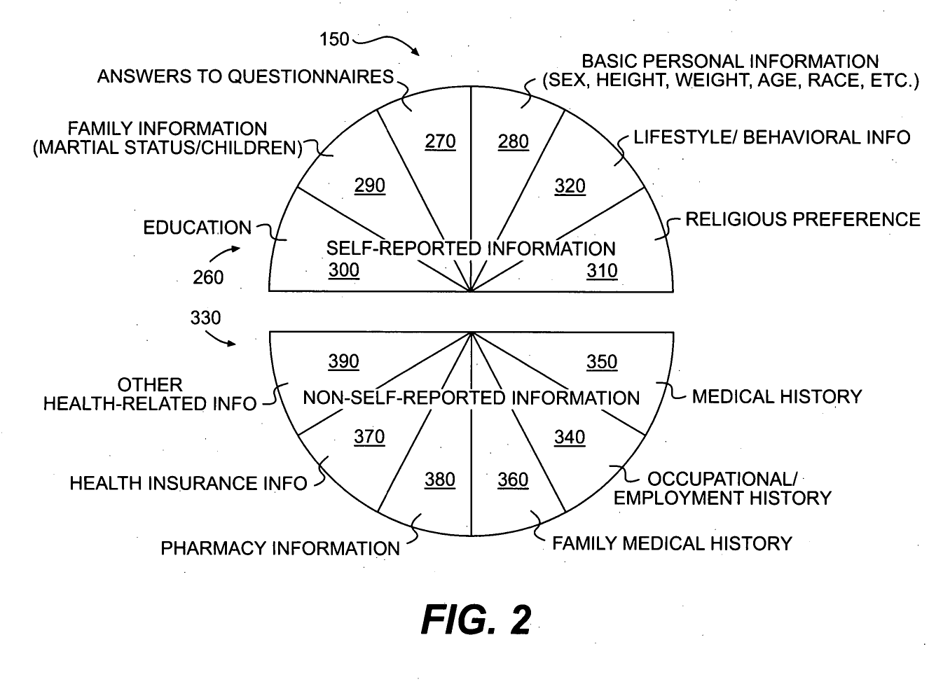

Health-related information may be stored in memory 160 in database 150. FIG. 2 illustrates one embodiment of database 150. Database 150 may include health-related information for a population of individuals. Database 150 may also include data for the population as a whole and/or selected portions of the population. Database 150 may further include individual health-related data for individual members of the population. Such individual data may include various information that may impact or otherwise relate to health-related issues. For example, database 150 may include self-reported information 260, which may be furnished by the individual members themselves. Self-reported information 260 may include information submitted by the individual members, for example, by filling out initial hiring paperwork for a particular employer. Alternatively or additionally, self-reported-information 260 may include information submitted through answers to or results of questionnaires (section 270).

Other types of self-reported information may include, for example, basic personal information such as sex, height, weight, age, race, etc. (section 280) and/or family information such as marital status and information about the children of the individuals (section 290). Self-reported-information 260 may also include information about the education of the individual members (section 300), religious preference (section 310), and/or any other personal information that may be affected by or have an affect on a health-related issue. Further, self-reported-information 260 may include lifestyle and/or behavioral information (section 320). Examples of health-related lifestyle and/or behavioral information may include information about whether the individual is a smoker or drinks alcohol, their sleep habits, diet, the geographic location and/or climate in which they reside, whether or not they engage in certain kinds of activities (e.g., sports, hiking, parachuting, scuba diving, etc.), and any other lifestyle or behavioral information that may be health-related.

Database 150 may also include non-self-reported information 330. Examples of non-self-reported information 330 may include information about an individual's occupational/employment history (section 340), medical history (section 350), and/or family medical history (section 360). Non-self-reported-information 260 may also include health insurance information (section 370), as well as pharmacy information (section 380). Such pharmacy information may include, for example, information about what prescriptions an individual member has taken (e.g., pharmacy records). Non-self-reported-information may include data such as medical claims data and/or pharmacy data.

It is within the scope of the present system to include any other type of health-related information in database 150 (section 390). Further, it should be noted that, while certain types of information have been discussed here as being examples of self-reported or non-self-reported, any type of information may be submitted in either manner. For example, an individual's marital status could be non-self-reported (e.g., obtained from another source, such as tax records). Similarly, although previously discussed as being non-self-reported, an individual's family medical history may be self-reported (e.g., through a survey).

Processor 170 may be operatively coupled to memory 160 and may be configured to assemble at least one tailored health-related information package tailored for an individual member of the population based on health-related information stored in memory 160 (e.g., from database 150). The tailored health-related information package may be assembled in response to an addition of new health-related information or an update to the health-related information stored in memory 160.

Such tailored health-related information packages may include health-related information that is tailored for the individual members to whom the informational packages may be administered. For example, an individual member who submits an answer to a prior questionnaire indicating that they are a smoker may be administered information about the harmful effects of smoking and/or information on quitting assistance programs, nicotine gum, etc.

Processor 170 may be configured to assemble at least one tailored HRA questionnaire package tailored for an individual member of the population. The tailored HRA questionnaire package or packages may be assembled in response to an addition of new health-related information to memory 160. Alternatively or additionally, the tailored HRA questionnaire package or packages may be assembled in response to an update to the health-related information stored in memory 160.

In some embodiments, an HRA questionnaire package may include separate targeted questions each associated with unrelated HRA strategies or health issues. In other embodiments, processor 170 may be configured to generate a tailored health-related information package including information about more than one unrelated HRA strategy or health issue. HRAs or health issues may be unrelated if, for example, they pertain to different medical disciplines (e.g., cardiology and oncology). HRAs or health issues may also be unrelated if, for example, they deal with differing aspects of medical care, such as routine checkups versus screening/diagnosis versus treatment. These distinctions are exemplary only and are intended, for purposes of this disclosure, to provide guidance with respect to the scope of the term “unrelated” as it pertains to health-related issues.

Processor 170 may be further configured to generate a tailored package for an individual member that includes both tailored questions and health-related information. In some embodiments, the health-related information may be incorporated into the tailored questions. For example, a tailored question may ask “How often do you exercise?” In some embodiments, health-related information may be included into the tailored question as follows: “How often do you exercise? (Exercising several times a week can be beneficial to your general health.)”

System 110 may be configured to alert an individual member about benefits that arise as a result of analysis of health-related information in database 150. For instance, in the case of a colorectal screening HRA strategy, processor 170 may be configured to inquire, based on an individual's age and sex, whether or not they have had a colonoscopy recently. In response to an indication that the individual has not had a recent screening, system 110 may be configured to provide one or more recommendations of local facilities at which such screenings may be performed. System 10 may also be configured to indicate to the individual whether or not such a screening is covered by the individual's health insurance.

System 10 may be configured to alert an individual member when the member is eligible for particular healthcare. For example, in the colorectal screening example above, once an individual reaches a certain age at which various industry authorities may suggest that such screening is appropriate, the screening may be covered by the individual's insurance. Once the healthcare is either suggested by industry sources and/or covered by insurance, system 110 may alert the individual of their eligibility for the healthcare.

Processor 170 may be configured to pre-authorize or otherwise indicate pre-authorization of health treatments based on the health-related information stored in database 150. Such pre-authorizations may be generated automatically. Alternatively or additionally, notification may be made to the individual automatically.

System 110 may be configured to maintain a record of what information and/or questions are administered to an individual. System 110 may be configured to store such data for purposes of analyzing the success of different interventions. Such data may also be used for, among other things, determining healthcare costs.

Tailored questions are those questions that may be administered to an individual member of the population based at least in part upon health-related information stored in database 150. In an exemplary embodiment, tailored questions may be built by defining a set of appropriate responses to various triggers, such as additions and updates to information in database 150. These tailored questions may define a set of potential questions to be administered to each individual in the population. Based on usage rules, a determination may be made for each individual member regarding which questions are appropriate for the individual and, further, which questions shall be administered to them.

If determined to be applicable and otherwise in compliance with the usage rules of system 110, individual paragraphs and/or sentences may be placed into a form letter. Through the use of individual paragraphs, instead of a letter-based model, greater flexibility may be given to assemble a single letter including information and questions about multiple HRA strategies. Thus, an individual who is a member of two different targeted populations, for instance colorectal cancer and smoking, and who receives both sets of HRA strategy questions may receive a single feedback letter including all feedback, instead of two feedback letters.

The tailored questions developed may be based on the expertise of the physicians or clinicians involved. Although not intended to be limiting, the present disclosure contemplates, at least, for example, the following four categories of questions.

A first category may include applicability questions. An applicability question may define whether further questions regarding a particular issue would be appropriate for the respondent of the questionnaire. For instance, a targeted smoking question may ask, “Do you currently smoke cigarettes?” This would alleviate the need for the respondent to answer further questions about their smoking habits if they do not smoke. While the question would generally not be posed to a non-smoker, the relevant personal data may be out of date or the person may have recently quit smoking.

A second category of questions may be in regard to contraindications. These questions may relate to whether a particular course of treatment or feedback suggestions are appropriate based on the respondents' medical history.

A third category of questions may be about barriers. Questions may be posed to determine what barriers to treatment might lie in the respondents' attitudes to treatment.

A fourth category of questions may relate to staging, or at what mental stage a respondent may be, in terms of readiness to proceed with treatment. In other words, what thought has the person put into proceeding with treatment and/or what is their level of readiness to do so. Processor 170 may be configured to determine, from health-related information stored in database 150, a level of readiness of the individual member to change their lifestyle or otherwise follow through with a health-related intervention (e.g., lifestyle changes, such as quitting smoking; medical screening, such as mammograms; and/or other types of medical therapy, such as taking medication) with regard to a particular health issue and base a composition of the tailored packages on the level of readiness determined by processor 170. For example, an individual over the age of 60 who smokes but has tried multiple times to quit may be administered one or more tailored questions regarding smoking cessation. Whereas, an individual over the age of 60 who smokes but has made no attempt to quit and expressed no interest in quitting may be administered one or more different questions.

Processor 170 may be configured to choose questions for assembly into tailored HRA questionnaires. Processor 170 may choose such questions on the basis of what is appropriate and/or desirable to administer to an individual member of the population based on a set of usage rules. For example, females would not see questions asking about their prostate screening history, but they may see questions directed at pregnancy, as well as questions generic to both sexes, such as cardiovascular health. Other possible usage rules are discussed in greater detail in the following paragraphs.

Processor 170 may be configured to prioritize the tailored questions of the questionnaire based on a priority respectively associated with various HRA strategies. HRA strategies may be prioritized so that when tailored questionnaires are generated by system 110, the questions relating to a particular strategy will appear in order of priority. Also, limits may be imposed on the length of a questionnaire. HRA strategies of lowest priority may be omitted or removed (e.g., by processor 170) from the generated tailored HRA questionnaire prior to administering the questionnaire to the individual, if inclusion of the tailored questions having a lowest priority would render the tailored questionnaire longer than a predetermined length limit.

Processor 170 may be configured to assemble questionnaires for individual members with a particular frequency. For example, questionnaires may be assembled and/or administered semi-annually, monthly, etc. Frequencies may be defined for how often questions in an HRA strategy should be administered to an individual. HRA strategy questions may be assigned a predetermined frequency with which they should be asked. This may reduce repetition and permit lower priority HRA strategy questions the opportunity to be posed when they might otherwise be blocked by higher priority HRA strategy questions.

Alternatively or additionally, questions may be administered to individuals with a predetermined timing. For example, diet tips may be administered shortly before holidays such as Thanksgiving and Christmas, which can often present opportunities to overeat. Also, for example, information on exercise may be administered around or shortly after the holidays, thus strategically coinciding with many people's New Year's resolutions to establish an exercise routine. The timing concept may also be used to block questions from being presented at certain times of the year or to trigger an HRA strategy to be presented. Frequency and timing of questions may also be tailored for each individual member or tailored to groups of members.

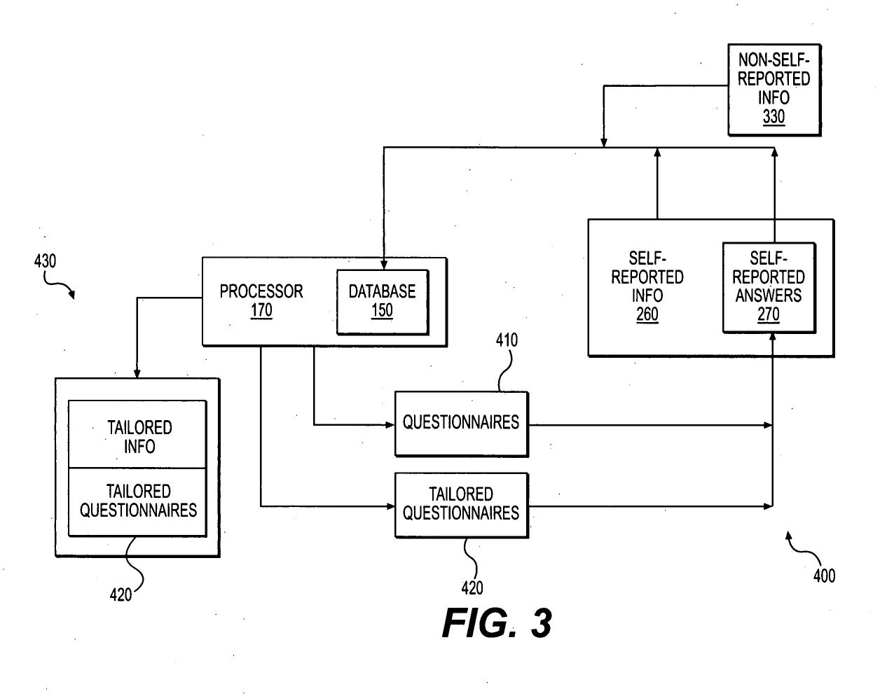

As illustrated in FIG. 3, system 110 may be configured to generate health-related information packages and HRA questionnaire packages independently from one another. Processor 170 may be configured to perform a database building function, illustrated by loop 400. Data may be added to database 150 in a number of different ways, from a number of different sources. For example, non-self-reported information 330 (e.g., pharmacy information 380, family medical history 360, etc.) may be stored in database 150. In addition, system 110 may perform an information gathering function by administering questionnaires to members of the population. System 110 may be configured to administer one or more general questionnaires 410 to part or all of the population. System 110 may also be configured to administer one or more tailored questionnaires 420 to individual members of the population. Such tailored questionnaires 430 may be administered to obtain additional information regarding a health condition or other health-related information about an individual. Self-reported information 260, such as self-reported answers 270 to either type of questionnaire, may be stored in database 150.

Non-self-reported information 330 and self-reported information 260 may be gathered and/or analyzed periodically. For example, the analysis may occur with any frequency including cycles that occur so frequently that they amount to real-time data analysis. For purposes of this disclosure, the term “real-time” shall refer to the immediate or substantially immediate availability of data to an information system as a transaction or event occurs. That is, data may be retrieved and available for analysis as quickly as it can be transmitted. Such transmissions may be virtually instantaneous or may take a few seconds or minutes to complete.

System 110 may be configured to determine, as part of the analysis of information in database 150, a risk that an individual member has of having or developing one or more predetermined medical conditions. System 110 may be configured to administer tailored information packages and/or tailored questionnaires to members who are determined to be at risk for a particular condition. System 110 may be configured to send tailored information packages and/or tailored questionnaires to members whose risk exceeds a predetermined amount. For example, system 110 may be configured to send tailored information to an individual if the risk of them developing heart disease is greater than 30%.

Processor 170 may be configured to perform this information gathering and/or analysis independently of the administration of any health-related information (function 430). Function 430 may include administering tailored health-related information based on determination of health risks. However, in some embodiments tailored questionnaires may be administered in conjunction with the tailored information.

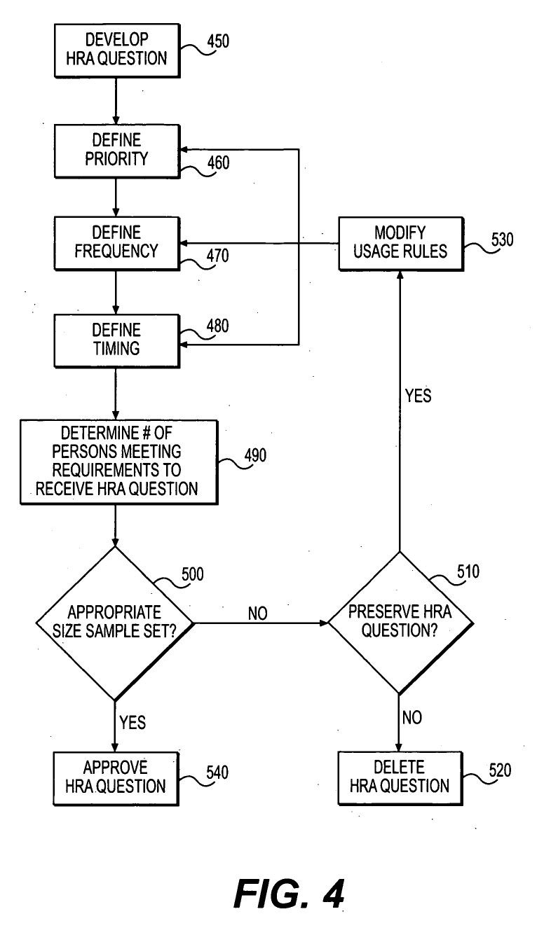

FIG. 4 is a flow chart of an exemplary process of determining the usage rules for a given HRA question. The process may begin with the development of an HRA question (step 450). The HRA question developed in step 450 may be created automatically by system 110 or may be established with the expertise of a physician. Once the HRA question has been developed in step 450, various usage rules may be established to govern the administration of such a question to individual members of the population. For example, the priority that the question will carry may be established in step 460. Continuing in no particular order, alternative or additional usage rules may be defined, such as frequency (step 470) and/or timing (step 480).

Once the usage rules are defined for an HRA question, processor 170 may apply the rules to the population to determine how may individuals meet the requirements to receive the HRA question (step 490). In step 500, a determination may be made as to whether the number of individuals that meet the requirements (the “sample set”) to receive the HRA question is appropriate and/or desired. If not, then a further determination may be made whether to preserve the HRA question (step 510). If the determination is made that the question is not to be preserved, then it may be deleted from system 110 (step 520). If the determination is made to keep the question, then the usage rules may be modified (step 530; e.g., redefining priority, frequency, timing, etc.) to achieve a different size sample set. For example, some questions may have usage rules with age ranges (e.g., in order to receive such a question an individual must be between the ages of 30 and 40). If the sample set is initially larger than desired, then the qualifying age range may be narrowed, which may reduce the size of the sample set. If the group size is determined to be satisfactory at step 500, then the HRA question may be approved for incorporation into one or more individual HRA questionnaires to be administered to one or more individuals (step 540).

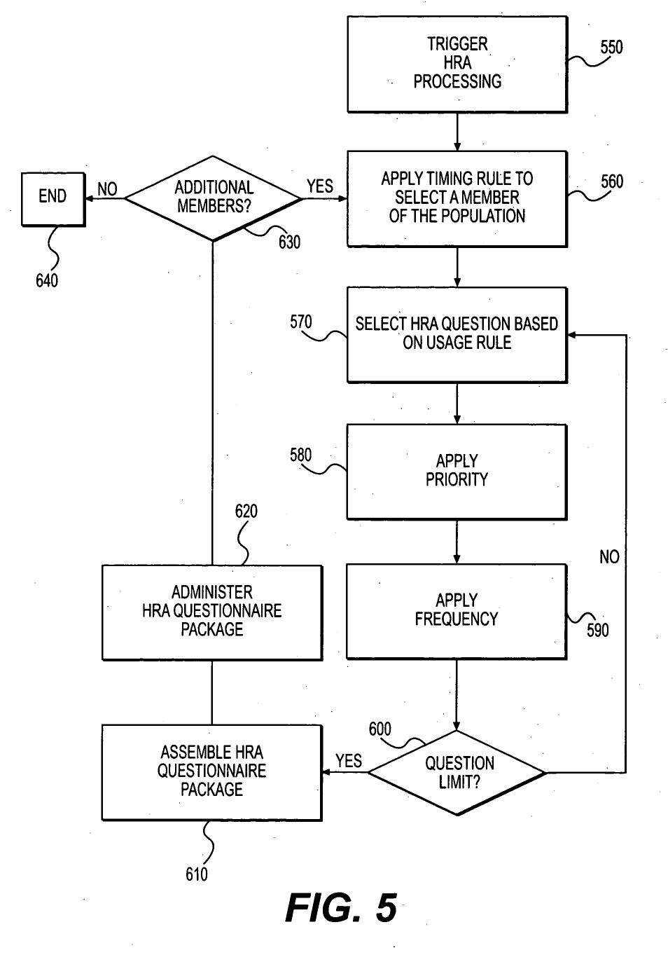

FIG. 5 is a flow chart illustrating the processing of an approved HRA question and assembly of an HRA questionnaire. HRA processing may be triggered (step 550) in response to any of the various triggers discussed herein. At step 560 an individual member of the population may be selected, based on application of a timing usage rule. For example, a particular HRA question or HRA questionnaires in general may have a timing rule establishing that the question or questionnaires in general shall be administered at a particular time of year (e.g., semi-annually). When the particular time of year comes around, system 110 may begin selecting individuals for potential receipt of an HRA questionnaire. At step 570, an HRA question may be selected based on usage rules. The priority of the HRA question may be applied (step 580) to determine which questions for which the individual qualifies have the highest priority (e.g., by ranking them in order of priority). A frequency rule may also be applied (step 590).

At step 600, processor 170 may determine whether addition of another HRA question to a questionnaire would exceed a question limit. If not, then the process may return to step 570 and select another HRA question for possible addition to the questionnaire. When the question limit is reached at step 600, flow may proceed to step 610, where the HRA questionnaire may be assembled by grouping together all the HRA questions to create an HRA questionnaire package. At step 620, the HRA questionnaire package may be administered to the individual member in any of the various ways discussed herein. It should be noted that although the administration of questionnaire packages is illustrated to occur after assembly of each package, a partial or complete collection of all packages may be administered after some or all of the packages have been assembled. Once the HRA questionnaire has been administered in step 620, system 110 may determine if there will be any additional members for which an HRA questionnaire package will be assembled (step 630). If so, flow may proceed back to step 560 where another member of the population may be selected.

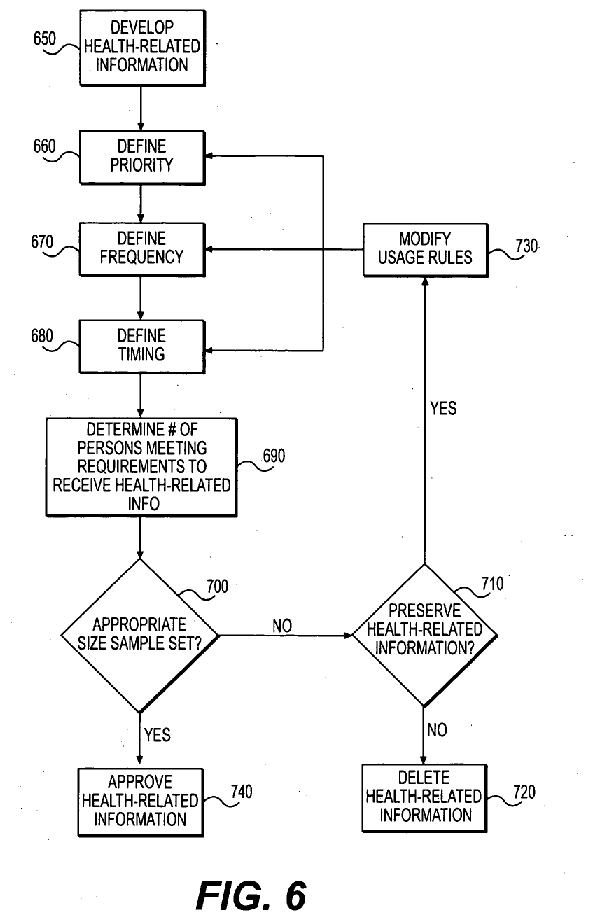

FIG. 6 is a flow chart of an exemplary process of determining the usage rules for a given piece of health-related information to be administered to one or more members of the population. The process may begin with the development of the piece of information (step 650). The information developed in step 650 may be established with the expertise of a physician. In some embodiments, the information developed in step 650 may be facilitated by system 110. Once the information has been developed in step 650, various usage rules may be established to govern the administration of such information to individual members of the population. For example, the priority that the piece of information will carry may be established in step 660. Continuing in no particular order, alternative or additional usage rules may be defined, such as frequency (step 670) and/or timing (step 680).

Once the usage rules are defined for a piece of health-related information, processor 170 may apply the rules to the population to determine how many individuals meet the requirements to receive the information (step 690). In step 700, a determination may be made as to whether the number of individuals that meet the requirements (the “sample set”) to receive the information is appropriate and/or desired. If not, then a further determination may be made whether to preserve the piece of information (step 710). If the determination is made that the information is not to be preserved, then it may be deleted from system 110 (step 720). If the determination is made to keep the information, then the usage rules may be modified (step 730; e.g., redefining priority, frequency, timing, etc.) to achieve a different size sample set. For example, some information may have usage rules with age ranges (e.g., in order to receive such a piece of information an individual must be between the ages of 30 and 40). If the sample set is initially larger than desired, then the qualifying age range may be narrowed, which may reduce the size of the sample set. If the sample set is determined to be satisfactory at step 700, then the information may be approved for incorporation into one or more tailored health-related information packages to be administered to one or more individuals (step 704).

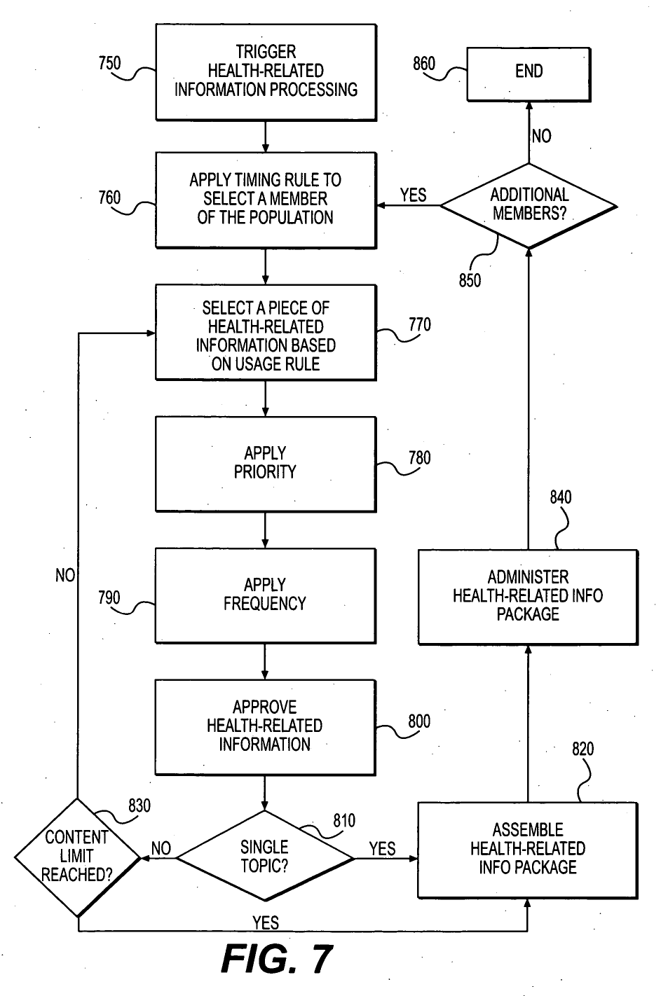

FIG. 7 is a flow chart illustrating the processing of an approved piece of health-related information and assembly of a tailored health-related information package. Information processing may be triggered (step 750) in response to any of the various triggers discussed herein. At step 760 an individual member of the population may be selected, based on application of a timing usage rule. For example, particular information may have a timing rule establishing that the information shall be administered at a particular time of year (e.g., semi-annually). When the particular time of year comes around, system 110 may begin selecting individuals for potential receipt of particular information. At step 770, a piece of information may be selected based on usage rules. The priority of the information may be applied (step 780) to determine which pieces of information for which the individual qualifies have the lowest priority (e.g., by ranking them in order of priority). A frequency rule may also be applied (step 790).

At step 800, the information may be approved for administration to members of the population. A determination may be made at step 810 whether the package is to contain a single topic. If so, then flow may proceed to step 820, where the tailored health-related information package may be assembled by grouping together all the approved pieces of information. If not, then at step 830, processor 170 may determine whether addition of another piece of information to a package would exceed a content limit. If not, then the process may return to step 770 and select another piece of information for possible addition to the package. When the content limit is reached at step 830, flow may proceed to step 820, where the tailored health-related information package may be assembled by grouping together all the approved pieces of information. At step 840, the tailored health-related information package may be administered to the individual member in any of the various ways discussed herein. It should be noted that although the administration of information packages is illustrated to occur after assembly of each package, a partial or complete collection of all packages may be administered after some or all of the packages have been assembled. Once the health-related information package has been administered in step 840, system 110 may determine if there will be any additional members for which a health-related information package will be assembled (step 850). If so, flow may proceed back to step 760 where another member of the population may be selected. If not, the process may end (step 860).

The foregoing description of exemplary disclosed embodiments has been presented for purposes of illustration and description. It is not exhaustive and does not limit the invention to the precise form disclosed. Modifications and variations are possible in light of the above teachings or may be acquired from practicing of the disclosed system. For example, the described implementation may include a particular network configuration but embodiments of the present disclosure may be implemented in a variety of data communication network environments using software, hardware, or a combination of hardware and software to provide the processing functions.

Those skilled in the art will appreciate that all or part of systems and methods consistent with the present disclosure may be stored on or read from other computer-readable media. System 110 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 110, such as, for example, computing platform 140, database 150, memory 160, processor 170, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these program modules may be implemented using commercially available software tools, including but not limited to custom object-oriented code written in the C++ programming language or applets written in the Java programming language. Further, these program modules may be implemented as discrete electrical components or as one or more hardwired application specific integrated circuits (ASIC) custom designed for this purpose.

The tailored HRA questionnaire packages and/or tailored health-related information packages may include paper documents, electronic documents, Internet-based documents, and any other suitable media for documentation. The packages may include paper or paper-like documents, such as pamphlets. Alternatively or additionally, the packages may include electronic documents, such as computer files. Such files may be administered to members of the population via various modes of transmission, such as email. Internet-based documents may include word processor type files and/or webpages, which may include the health-related information and/or questionnaires. Administration of such documents may include notifying members in any suitable way of the availability and/or accessibility of such documents, and may provide an Internet address for accessing the documents.

Implementation of the disclosed system may be, to some extent, undertaken by hand. For example, the determination of which questions and/or information will be administered to individual members of the population and/or the assembly of questionnaires may be handled by one or more persons, e.g., managers or administrators of the system. It is contemplated, however, that either a manual, semi-computerized, or fully computerized implementation may be utilized.

### INDUSTRIAL APPLICABILITY

The present disclosure may be applicable to health and wellness fields. The present disclosure may have particular applicability in the healthcare industry. For example, the system may have widespread application in the insurance industry, within corporations trying to control costs, and for any group concerned with improving the health and lifestyle of its members. Exemplary groups may include various types of organizations, such as companies, corporations, governments, military organizations, educational institutions, etc.

The present disclosure may provide a way to significantly reduce costs associated with healthcare by providing meaningful, tailored questionnaires and information to individuals seeking to improve their health. Tailored questionnaires can provide members with individualized questionnaires, which may be focused in any number of ways (e.g., severity, priority, cost, treatability, etc.). Tailored questionnaires may be generated in response to factors, such as demographics, insurance claims information, pharmacy information, etc.

Tailored questionnaires can provide additional flexibility and/or efficiency in the HRA process by enabling the combination of questions and other health-related information from multiple HRA strategies to be included in the same tailored questionnaire. For example, rather than providing separate pamphlets for different health-related issues, a single document could include information addressing several health-related issues (e.g., cancer, arthritis, heart disease). In addition, a single document (e.g., an informational pamplet or questionnaire) may include both health-related information and targeted questions. The targeted questions may also include health-related information incorporated into the question.

Tailored and comprehensive questionnaires may reduce the number of questionnaires administered to individual members and/or the population as a whole. Such a reduction in the number of questionnaires may simplify the HRA process. For example, instead of determining priority questions and length of questionnaires for several questionnaires for each person, these determinations may be made for a single questionnaire. In addition, reduced numbers of questionnaires and/or questions are also more likely to elicit responses from individual members. Questionnaires that are tailored to individuals are also more likely to be completed. Questionnaires that vary over time are also more likely to be completed. For similar reasons, review of completed questionnaires and analysis of the associated data may also be more likely and/or achievable as a result of tailoring the questionnaires to individuals and/or including questions pertaining to unrelated health issues in the same questionnaire. Tailoring the feedback to the individual also increases self-efficacy for enhancing lifestyle and improvement of lifestyle choices.

An advantage of the present disclosure is that it contemplates assembling a tailored questionnaire and/or information package in response to triggers other than answers or results being received for questionnaires previously administered to a given member. While system 110 may be configured to assemble tailored questionnaires and/or information packages in response to answers to or results of previously administered questionnaires, tailored questionnaire packages may also be generated in response to a number of different other triggers.

An exemplary trigger may include updates to health-related information in database 150. For example, a member turning a particular age (i.e., update to age data) may trigger administration of tailored information and/or questions to that individual. Alternatively or additionally, another exemplary trigger may include the addition of new information to database 150. For example, system 110 may be configured such that even if an individual had no prior history of diabetes and never responded to any questionnaire regarding diabetes, system 110 may generate a tailored questionnaire package including questions and/or information about diabetes in response to a trigger such as a recent pharmacy record indicating that the individual obtained a prescription for insulin. Thus, a more proactive strategy may be employed by furnishing individuals with tailored questionnaires and/or health-related information about one or more health issues despite no voluntary submission of self-reported information on the part of the individual.

Although the tailored questionnaires may be assembled from pre-established questions, the assembly of such questionnaires may take place after, and as a result of the updates to information in or addition of information to database 150. Exemplary methods of using system 110 may include pre-authorizing health treatments based on health-related information stored in memory 160. Alternatively or additionally, such methods may include alerting the individual member when the member is eligible for particular healthcare. In this way, time and money may be conserved by leveraging the information gathered by the process. Also, the lifestyle of the individual member may be further enhanced by the simplification of seeking and receiving medical treatment.

The methods may include storing, in memory 160, at least one of insurance information and pharmacy information. The methods may further include administering at least one tailored HRA questionnaire package to an individual member of the population. The methods may also include tailoring at least one of a frequency and a timing of the administering of tailored HRA questionnaire packages to the individual member. Additionally, the methods may include generating the tailored packages in the form of at least one of a paper document, an electronic document, and an Internet-based document.

It will be apparent to those having ordinary skill in the art that various modifications and variations can be made to the disclosed health and wellness guidance system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A health and wellness guidance system, comprising:
a memory configured to store health-related information about individual members of a population; and
a processor operatively coupled to the memory and configured to assemble at least one tailored health risk assessment questionnaire package tailored for an individual member of the population in response to at least one of the following:
an update to the health-related information stored in the memory; and
an addition of new health-related information to the memory.

2. The system of claim 1, wherein the tailored health risk assessment questionnaire package includes at least two tailored questions respectively associated with at least two unrelated health risk assessment strategies.

3. The system of claim 1, wherein the processor is further configured to generate a tailored health-related information package including information about at least two unrelated health issues.

4. The system of claim 1, wherein the tailored health risk assessment questionnaire package includes both tailored questions and health-related information.

5. The system of claim 4, wherein the health-related information is incorporated into the tailored questions.

6. The system of claim 1, wherein the processor is further configured to pre-authorize health treatments based on the health-related information stored in the memory.

7. The system of claim 1, wherein the system is further configured to alert the individual member when the member is eligible for particular healthcare.

8. The system of claim 1, wherein the memory is further configured to store at least one of insurance information and pharmacy information.

9. The system of claim 1, wherein the processor is configured to administer tailored health risk assessment questionnaire packages to an individual member with a predetermined frequency and timing that are tailored for the individual member.

10. The system of claim 1, wherein the tailored health risk assessment questionnaire package includes at least one of a paper document, an electronic document, and an Internet-based document.

11. A method for guiding health and wellness behavior of members of a targeted population, comprising:
assembling at least one tailored health risk assessment questionnaire package tailored for an individual member of the population in response to at least one of the following:
an update to health-related information stored in a memory; and
an addition of new health-related information to the memory.

12. The method of claim 11, wherein the tailored health risk assessment questionnaire package includes at least two tailored questions respectively associated with at least two unrelated health risk assessment strategies.

13. The method of claim 11, further including generating a tailored health risk assessment questionnaire package including both tailored questions and health-related information.

14. The method of claim 13, further including incorporating the health-related information into the tailored questions.

15. The method of claim 11, further including pre-authorizing health treatments based on health-related information stored in the memory.

16. The method of claim 11, further including alerting the individual member when the member is eligible for particular healthcare.

17. The method of claim 11, further including storing, in the memory, at least one of insurance information and pharmacy information.

18. The method of claim 11, further including administering the at least one tailored health risk assessment questionnaire package to the individual member.

19. The method of claim 11, further including tailoring at least one of a frequency and a timing of the administering of tailored health risk assessment questionnaire packages to the individual member.

20. The method of claim 11, further including generating the tailored packages in the form of at least one of a paper document, an electronic document, and an Internet-based document.

21. A computer-readable medium having stored thereon machine executable instructions for guiding health and wellness behavior of members of a population, the instructions comprising the step of:
assembling at least one tailored health risk assessment questionnaire package tailored for an individual member of the population in response to at least one of the following:
an update to health-related information stored in a memory; and
an addition of new health-related information to the memory.

22. The computer-readable medium of claim 21, wherein the tailored health risk assessment questionnaire package includes at least two tailored questions respectively associated with at least two unrelated health risk assessment strategies.

23. The computer-readable medium of claim 21, wherein the tailored health-related information package includes information about at least two unrelated health issues.

24. The computer-readable medium of claim 21, further including instructions for generating a tailored health risk assessment questionnaire package for a member of the population including both tailored questions and health-related information.

25. The computer-readable medium of claim 24, wherein the health-related information is incorporated into the tailored questions.

26. The computer-readable medium of claim 21, further including instructions for pre-authorizing health treatments based on health-related information stored in the memory.

27. The computer-readable medium of claim 21, further including instructions for alerting the individual member when the member is eligible for particular healthcare.

28. The computer-readable medium of claim 21, further including instructions for storing, in the memory, at least one of insurance information and pharmacy information.

29. The computer-readable medium of claim 21, further including instructions for administering the at least one tailored health risk assessment questionnaire package to the individual member.

30. The computer-readable medium of claim 29, further including instructions for tailoring at least one of a frequency and a timing of the administering of tailored health risk assessment questionnaire packages to the individual member.

31. The computer-readable medium of claim 21, further including instructions for generating tailored health risk assessment questionnaire packages in the form of at least one of a paper document, an electronic document, and an Internet-based document.
